(19) United States
(12) Patent Application Publication
(10) Pub. No.: US 2008/0024002 A1
(43) Pub. Date: Jan. 31, 2008

(54) Wheel protector

(76) Inventor: Scott A. Guthrie, Jefferson, PA (US)

Correspondence Address: JAMES RAY & ASSOCIATES, 2640 PITCAIRN ROAD, MONROEVILLE, PA, 15146, US

(21) Appl. No.: 11/881,028

(22) Filed: Jul. 25, 2007

Related U.S. Application Data
(60) Provisional application No. 60/833,051, filed on Jul. 25, 2006.

(51) Int. Cl. B60B 7/08

(52) U.S. Cl. 301/37.104

(57) ABSTRACT

A wheel rim cover with a dome shaped shield with an open end, closed end and predetermined radius. The shield a circumferential rim at the open end and a generally right angle shaped handle at the closed end. The handle has a cavity of predetermined radius to accommodate a hook or peg for storage of the cover. In the preferred embodiment the handle is attached at the center of the closed end of the shield and the dome shape is a spherical cap.

### CROSS REFERENCE TO RELATED APPLICATION

This patent application is related to and claims priority from U.S. Provisional Patent Application Ser. No. 60/833,051 filed Jul. 25, 2006.

### FIELD OF THE INVENTION

The present invention relates, in general, a shield for tire rims for used in detailing and, more particularly, this invention relates to an improved shield with a rim and handle.

### BACKGROUND OF THE INVENTION

Prior to the conception and development of the present invention, as is generally well known in the prior art, shields have been used to protect tire rims from caustic and corrosive chemicals used in the meticulous cleaning and preparation of vehicles known as detailing. Previous inventions have used shields with various forms of handles to allow the positioning of the shield while applying the cleaning agent with rag or aerosol. The conventional shield uses a curved surface which comes to an intersects a flat planar surface to form an edge. Prior inventions have used openings to place the hand within the shield or closed exterior handles which presents a problem of using a bulky protective glove on the positioning hand.

### SUMMARY OF THE INVENTION

The present invention provides a generally dome shaped shield with a circumferential rim and a handle with a cavity to permit the shield to be mounted on a hook and to be conveniently stored. In the preferred embodiment, the handle is a generally right angle shaped and is attached at a single point. The circumferential rim improves protection of the wheel rim from cleaning agent drips.

The shield in its preferred embodiment is made of plastic and be manufactured in various sizes to fit standard tire rim sizes and in various colors.

### OBJECTS OF THE INVENTION

It is, therefore, one of the primary objects of the present invention to provide a shield to protect tire rims from caustic or corrosive cleaning agents used in detailing tires.

Another object of the present invention is to provide a shield with a rim to provide improved protection for dripping cleaning agents used in detailing.

Still another object of the present invention is to provide a shield with a convenient hand grip affixed at one point to allow the shield to be positioned with one hand while applying cleaning agents with the free hand.

Yet another object of the present invention is to have a cavity in the handle of the shield to allow it to be mounted on a hook or peg and conveniently stored.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the shield and a tire with rim.

FIG. 2 is a side elevational view of the shield.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

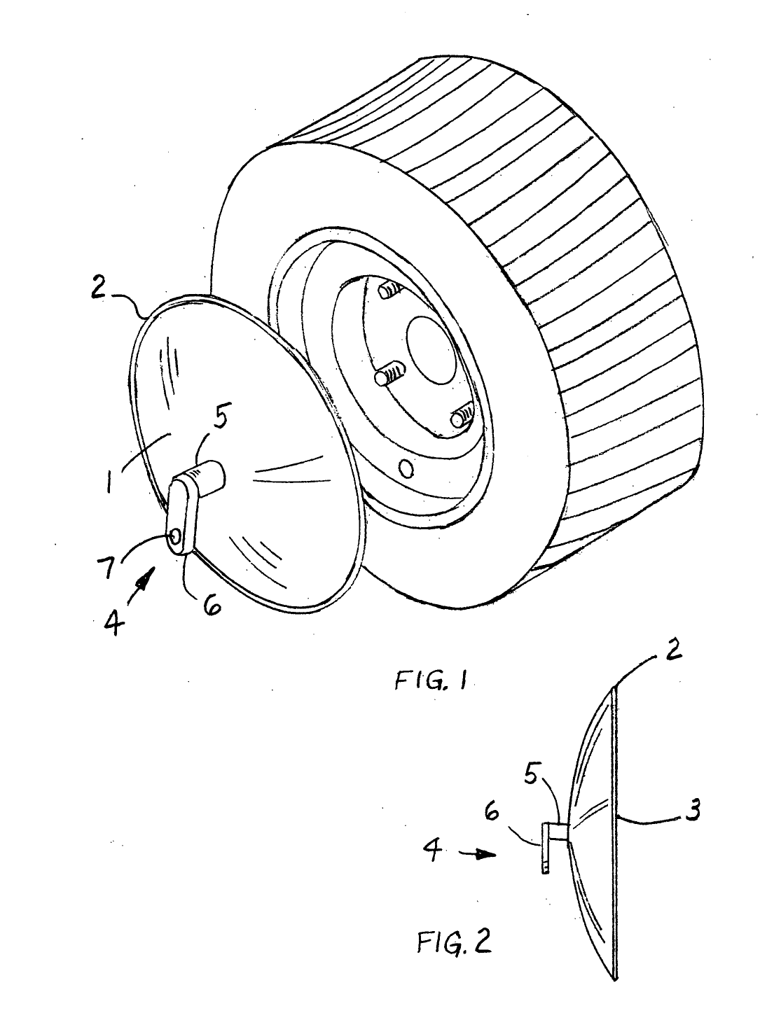

Reference is now made, more particularly, to FIG. 1 and FIG. 2 a generally dome shaped shield 1 having an open end 3 and a closed end. The open end has a circumferential ring 2. The circumferential rim has a predetermined height which permits it to hold excess droplets of cleaning agent used in detailing preventing drips onto the tire surface. In the preferred embodiment, the dome shape shield 1 is a spherical cap. The generally dome shape cover accommodates the hub of a tire mounted on a vehicle. The radius of open end 3 is predetermined according to the size of various conventional wheel rims.

A handle 4 is attached to the closed end of shield 1. The handle 4 is securely attached to the closed end preferably at the central point of minimum radius of the shield 1. The preferred embodiment is to bolted handle 4 to shield 1. The handle 4 is generally right angle shaped with an axial member 5 and a radial member 6. The length of the axial 5 and radial member 6 is predetermined so that the handle can be comfortably grasped by the user. The right angle shaped handle 4 is an open handle because is attached at only one point so that user has improved access. Handle 4 permits the user to grasp the radial member 6 of handle 4 with a bulky gloved hand. The handle 4 provides access to the gloved hand so as not to come into contact with the shield and any excess cleaning agent which may accumulate in use during detailing.

Handle 4 has a cavity 7 of a predetermined diameter to receive a peg or hook. The cover can then be conveniently stored by hanging it when not in use.

In the preferred embodiment, the shield 1 is manufactured from plastic in a various colors. However, the shield 1 could also be manufactured of metal. The preferred metal for manufacture is aluminum.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A wheel rim cover comprising:
a generally dome shaped shield of a predetermined material, having a closed end and an open end with a predetermined radius;
a circumferential rim of predetermined height;
a handle attached to said shield.

2. A wheel rim cover according to claim 1 wherein said handle is generally right angle shaped and attached to said shield.

3. A wheel rim cover according to claim 1 wherein said handle includes a cavity of predetermined diameter to receive a hook or peg.

4. A wheel rim cover according to claim 1 wherein said handle is attached to said shield at the generally center point of said shield.

5. A wheel rim cover according to claim 1 wherein said generally dome shape is a spherical cap.

6. A wheel rim cover according to claim 1 where in said predetermined material is of a group of plastic or metal.

7. A wheel rim cover according to claim 1 wherein said predetermined material is plastic.

8. A wheel rim cover according to claim 7 wherein each of said shield is available in a plurality of colors.

9. A wheel rim cover according to claim 6 wherein said metal is aluminum.

10. A wheel rim cover comprising:
a generally dome shaped shield of a predetermined material, having a closed end and an open end with a predetermined radius;
a circumferential rim of predetermined height;
a handle attached to said shield;
a cavity in said handle of predetermined diameter that may receive a hook.

11. A wheel rim cover according to claim 10 wherein said handle is generally right angle shaped and attached to said shield.

12. A wheel rim cover according to claim 10 wherein said handle is attached to said shield at the generally center point of said shield.

13. A wheel rim cover according to claim 10 wherein said generally dome shape is a spherical cap.

14. A wheel rim cover according to claim 10 where in said predetermined material is of a group of plastic or metal.

15. A wheel rim cover according to claim 10 wherein said predetermined material is plastic.

16. A wheel rim cover according to claim 15 wherein each of said shield is available in a plurality of colors.

17. A wheel rim cover according to claim 14 wherein said metal is aluminum.
